(19) United States
(12) Patent Application Publication
(10) Pub. No.: US 2009/0254382 A1
(43) Pub. Date: Oct. 8, 2009

(54) Dynamic Rate Management System for Golf Facilities

(76) Inventor: Andrew D. Weeks, Flossmoor, IL (US)

Correspondence Address: LAW OFFICES OF EUGENE M. CUMMINGS, P.C., ONE NORTH WACKER DRIVE, SUITE 4130, CHICAGO, IL, 60606, US

(21) Appl. No.: 12/098,144

(22) Filed: Apr. 4, 2008

(51) Int. Cl. G06Q 10/00

(52) U.S. Cl. 705/5

(57) ABSTRACT

A method for dynamically pricing rounds of golf utilizing a price matrix based on customizable parameters, whereby the rates may be structured in a way as to incite golfers to reserve tee times in advance and wherein said price matrix displays to a user simultaneously a plurality of different rates and associated rate amounts that are associated with a selected tee time.

### FIELD OF THE INVENTION

The present invention relates generally to dynamic rate management software to manage and optimize the utilization of golf facilities and is particularly directed to dynamic rate management software implementing a price matrix. The invention is disclosed as a method for dynamically managing rates for golf facilities utilizing a rate management system including a plurality of pricing rules for defining a price matrix.

### DESCRIPTION OF THE PRIOR ART

The game of golf has established itself as a major sport and provides recreational opportunities and enjoyment for millions of people in the United States. Golfing is also a major economy in its own right. It has been estimated that in 2005 nearly 40 million golfers could choose from more than 16,000 golf facilities in the United States alone. These golf facilities are at the center of any golf economy and are the largest component in terms of revenue.

The revenue that flows through a golf facility comes primarily from green fees, membership fees, range fees, golf car rentals, and associated spending on food and beverages. For the year 2005 golf facility revenues for the United States have been estimated at about US$28 billion.

The industry's revenue growth was also aided by increased use of technology, such as the use of tee-sheet management software and the ability to let golfers reserve tee times over the Internet. However, the ever increasing number of golf facilities has also intensified competition between golf facilities. A combination of oversupply in the industry and the growth of last-minute discount websites has led to weakened price integrity and brand loyalty. Providing golfers with a strong incentive to wait for last-minute discounts to reserve a round of golf has caused many golf facilities to lose some control of their pricing and tee time distribution.

Last-minute pricing has been a widespread pricing model in other industries as well, such as the travel and airline industries. Yet, even when reserving at a last-minute price, the customer is not presented with any options and it is not clear that the customer got the best deal. Another, more transparent approach to pricing is to present to the customer a price matrix. A price matrix generally displays different available prices for a common set of predetermined parameters, helping the consumer to make a more informed purchasing decision.

It would therefore be desirable if golf facilities would be provided with dynamic rate management software that improves the utilization of a golf facility's available capacities by providing greater control over pricing and tee time distribution. The disclosed method for managing rates by creating pricing rules and presenting those rules in a side-by-side price matrix allows golf facilities to incite golfers to make their reservations further in advance instead of waiting for last minute deals. The price matrix presents to the golfer, side-by-side, multiple rates for the same desired tee time; the further out the desired tee time the lower the rate when the reservation is made today. The disclosed method will help golf facilities separate convenience-oriented golfers from value-oriented golfers to optimize average daily rates while optimally filling the facility.

### OBJECTS OF THE INVENTION

Accordingly, it is an object of this invention to provide golf facilities with dynamic rate management software that improves the utilization of a golf facility's available capacities by providing greater control over pricing and tee time distribution. It is a further object of this invention to manage rates for tee times by creating pricing rules and presenting those rules in a side-by-side price matrix to allow golf facilities to incite golfers to reserve tee times further in advance. More particularly, the price matrix simultaneously presents to a user a plurality of different rates for a particular selected tee time, whereby the rates for the selected tee time are lower the more days in advance of the selected tee time the price matrix is displayed to the user.

### SUMMARY OF THE INVENTION

To achieve the foregoing and other advantages, and in accordance with one aspect of the present invention, a method for creating and displaying a dynamic price matrix that enables a user to reserve a selected tee time on a selected golf facility is provided, the method comprising the steps of: defining one or more tee times available at a particular golf facility; establishing one or more pricing rules for said tee time, said pricing rule dynamically controlling the rates and associated rate amounts at which said selected tee time is made available for reservation by said user; and displaying to said user simultaneously a plurality of different rates and associated rate amounts that are associated with said selected tee time whereby the basis of the different associated rate amounts is the number of days that are between said selected tee time and the day said user makes the reservation.

In accordance with another aspect of the present invention, a method for dynamically managing rates for golf facilities utilizing a rate management system including a plurality of pricing rules for defining a price matrix is provided, in which the method comprises the steps of: establishing at least one rate by defining a plurality of rate settings and naming and storing said at least one rate in a rate management database coupled to said rate management system; establishing at least one rate group by defining a plurality of rate group settings and naming and storing said at least one rate group in said rate management database coupled to said rate management system; establishing at least one rate band by defining a plurality of rate band settings and naming and storing said at least one rate band in said rate management database coupled to said rate management system; establishing at least one of said plurality of pricing rules wherein creating each one of said pricing rules includes 1) selecting at least one of said rates stored in said rate management database and assigning said selected rate to said one pricing rule, 2) selecting at least one of said rate groups stored in said rate management database and assigning said selected rate group to said one pricing rule, 3) selecting at least one of said rate bands stored in said rate management database and assigning said selected rate band to said one pricing rule; naming and storing said one pricing rule in said rate management database; assigning said one pricing rule to one or more specific dates; and storing said rule assignment in said rate management database for subsequently displaying said rule assignment in a price matrix.

In accordance with yet another aspect of the present invention, a method for dynamically managing rates for golf facilities utilizing a rate management system including a plurality of pricing rules for defining a price matrix is provided, wherein said price matrix displays rule assignments for a particular golf facility by presenting to said user for a selected tee time simultaneously a plurality of different available established rates and their associated rate amounts for an associated rate group, whereby said available associated rate amounts, in accordance with said established pricing rule, are different depending on the number of days between said selected tee time and the time said user makes a reservation for said selected tee time.

Still other advantages of the present invention will become apparent to those skilled in this art from the following description and drawings wherein there is described and shown a preferred embodiment of this invention in one of the best modes contemplated for carrying out the invention. As will be realized, the invention is capable of other different embodiments, and its several details are capable of modification in various, obvious aspects all without departing from the invention. Accordingly, the drawings and descriptions will be regarded as illustrative and not as restrictive.

### BRIEF DESCRIPTION OF THE DRAWINGS

Although the characteristic features of this invention will be particularly pointed out in the claims, the invention itself, and the manner in which it may be made and used, may be better understood by referring to the following description taken in connection with the accompanying drawings forming a part hereof, wherein like reference numerals refer to like parts throughout the several views and in which:

FIG. 1 depicts one embodiment of a price matrix displayed to a user;

FIGS. 2A through 2D depict embodiments of a graphical user interface allowing an administrator user to define rate, rate group, rate band and channel settings;

FIG. 3A depicts one embodiment of a graphical user interface allowing an administrator to establish a rule by assigning rates, rate groups and rate bands to a rule grid;

FIG. 3B depicts one embodiment of a graphical user interface after a user has assigned rates, rate groups and rate bands to a rule grid;

FIG. 3C depicts one embodiment of a graphical user interface for defining and modifying channel settings;

FIG. 3D depicts one embodiment of a graphical user interface for defining and modifying certain rate settings, including the rate amount;

FIG. 3E depicts one embodiment of a graphical user interface for defining and modifying certain rate groups;

FIG. 4 depicts one embodiment of a graphical user interface allowing an administrator user to assign rules to a specific day.

### DETAILED DESCRIPTION OF THE ILLUSTRATED EMBODIMENT

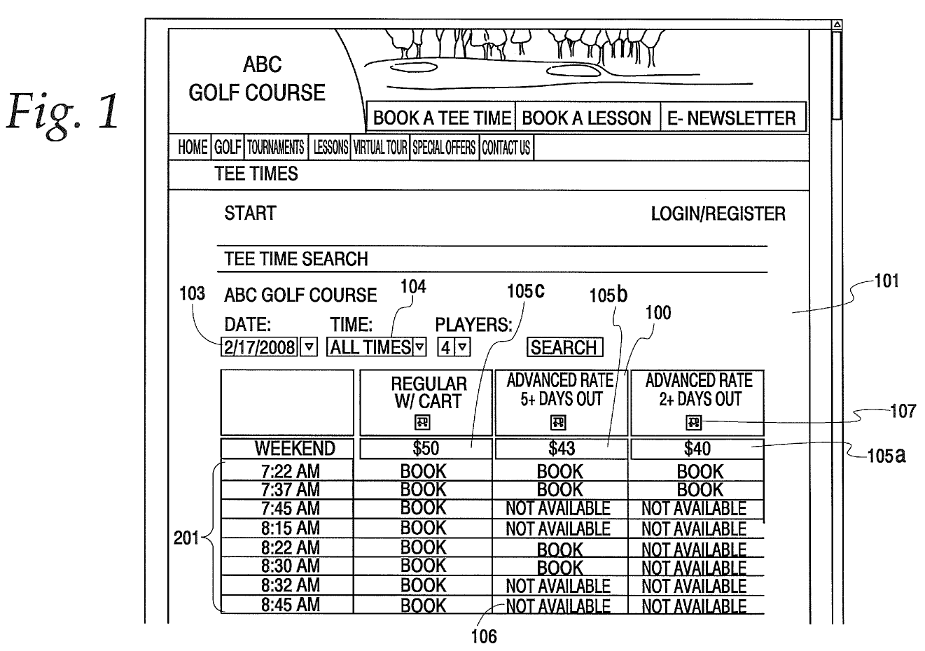

The disclosed invention provides for improved functionality of dynamic rate management software for golf facilities, by utilizing the concept of matrix pricing, allowing a golf facility to maximize utilization of available capacities by dynamically managing rate structures in a way that creates incentives for value-oriented golfers to commit earlier to less valuable tee times. The incentive to make a reservation in advance is created by presenting different rates for the same tee time in a side-by-side price matrix, whereby the rates are lower for tee times that are further out in time. FIG. 1 shows one embodiment of a price matrix 101 displayed to a user. In this example, the user selected the date and time(s) for the desired tee off time, by selecting a date from the tee date selector 103 and times from the tee time selector 104. For the selected date the price matrix 101 displays three different rates 100 for various tee times 201, i.e., the rate names a “Regular w/Cart” rate, an “Advanced Rate 2+ Days Out” and an “Advanced Rate 5+ Days Out.” For example, teeing off at 7:22 AM on an upcoming weekend would cost $40 if the reservation is made at least five days in advance. See rate amount 105a. The rate amount 105b would increase to $43 if the tee time is reserved at least two days in advance. Finally, the rate amount 105c is the highest at $50 if the tee time is less than two days in the future. Here, the differentiating factor between the different rate amounts for teeing off at 7:22 AM is the number of days that are between the tee time and the time the user makes the reservation. Whether a particular tee time is available for reservation is indicated by availability indicators 106. The price matrix 101 may further display tee icons 107, symbolizing certain rate restrictions or inclusions.

The disclosed dynamic rate management software may interface with existing legacy tee sheet management software to display available tee times. The disclosed software may be hosted, for example, on computer server(s) controlled by golf facility or a third party service provider and may be used, for example, (1) on a golf facility's website as an online reservation tool (see FIG. 1) to be used by a golfer, (2) in a golf facility's office to be used by staff to handle walk-in or phone reservations, and/or 3) in a centralized reservation center to be used by staff to handle phone reservations.

### Customization of the Price Matrix

In the preferred embodiment, a user with administrative rights has the ability to customize the price matrix to meet the needs of the particular golfing facility. The key aspect of the disclosed method is the creation of rules that define the price matrix for a given golf course on a given day. In the preferred embodiment, every rule incorporates rate settings, rate group settings, rate band settings and channel settings. Rate group settings allow a user to define traditional price breakdowns and rate structures used in the golf industry, for a selected golf facility. The price breakdowns, i.e., rate groups, incorporate different rates for different days-of-the-week and times-of-the-day. Rate groups provide groupings for applying actual prices to a rate. Rate band settings define rate bands, which are a subset of rate groups. A rate band allows an administrator to limit the number of times a tee time can be sold at a certain rate on a given day. For example, a golf facility may want to limit the available number of advanced rates at peak hours between 8 AM and 11 AM.

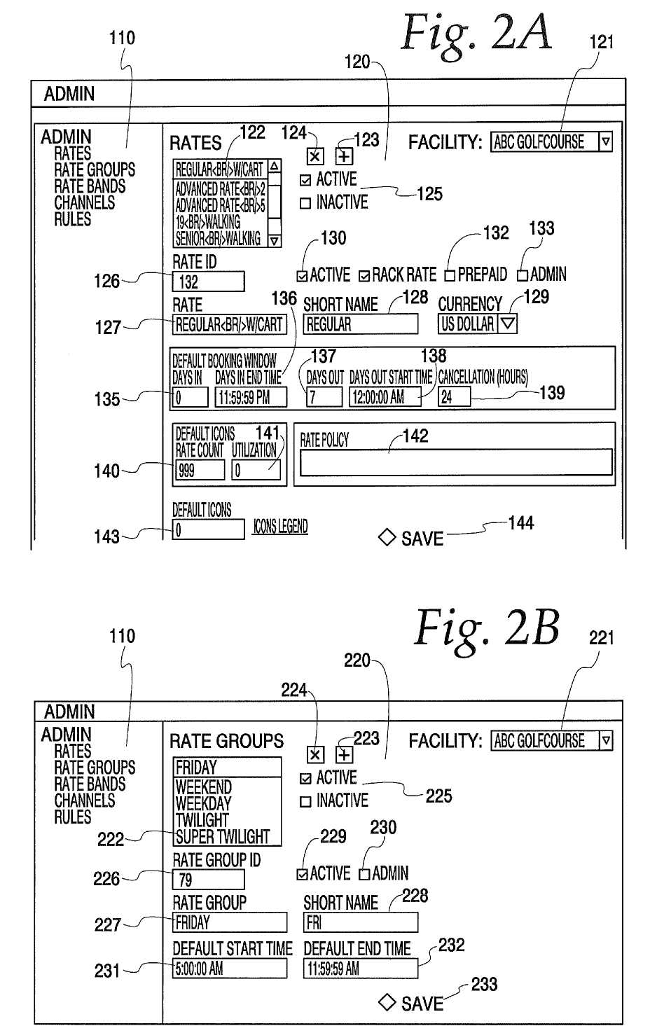

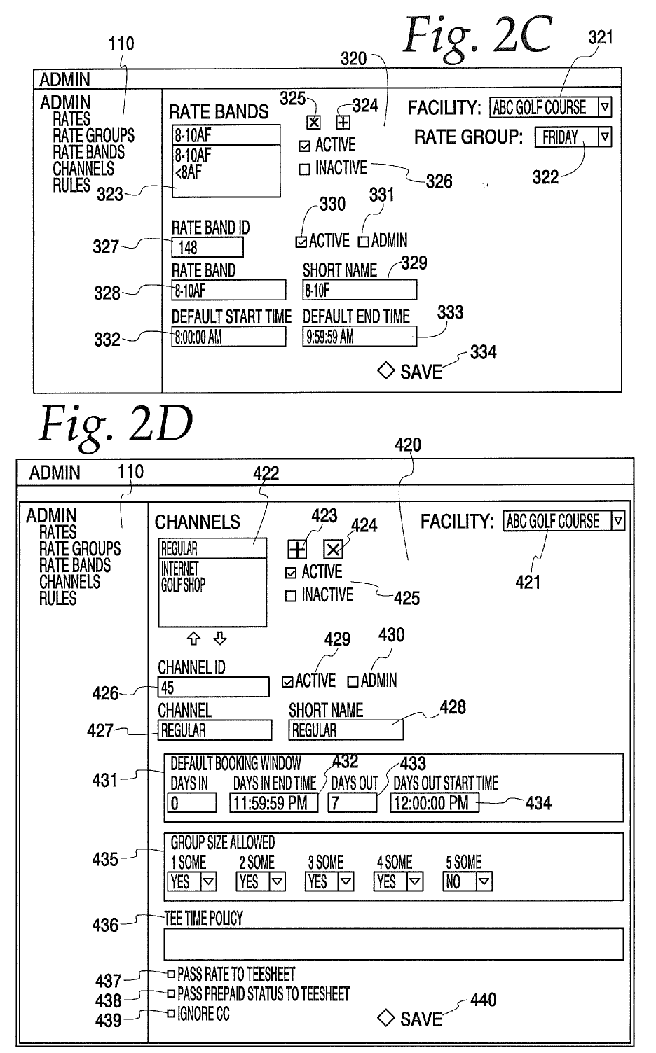

FIG. 2A shows one embodiment of a graphical user interface allowing an administrator to edit and save certain rate settings 120, which determine the details of a rate displayed in the price matrix. A user can select the rate settings 120 using pricing rule menu 110. The user may be given the option to select a golf facility from a list of golf facilities using golf facility selector 121. The user may, with regard to the selected golf facility, select an existing rate from a list of existing rates to be edited using rate selector 122. Alternatively, the user may also create a new rate by selecting create new rate 123 or delete an existing rate by selecting delete rate 124. The user further may have the option to indicate whether rate selector 122 should list active rates, inactive rates or both by using filter 125.

Other editing options for a selected or new rate shown in FIG. 2A relate to the identification of the selected rate. Each rate can be given a rate name 127 that may describe key aspects of the selected rate and an abbreviated short rate name 128. The user may also select the applicable rate currency 129. Rate ID 126 is a unique identification for a selected rate which is automatically assigned by the system and cannot be edited by the user. Rate activation 130 allows the user to designate the selected rate as active or inactive. That designation is used by filter 125. The user may further require a golfer to prepay for the selected rate by checking the prepaid indicator 132. The system may also allow the user administrator to check administration setting 133, indicating that the selected rate will only be visible to a user administrator to edit or to use in a rule.

Other default settings may include, but are not limited to days in 135, days in end time 136, days out 137, days out start time 138, cancellation 139, rate count 140, utilization 141 and rate policy 142. All of these default settings can be edited for a selected rate within a specific rule. Days in 135 and days in end time 136 indicate how close to a tee time the selected rate can be reserved. For example, when defining an advanced rate, the rate may be set to expire two days from a tee time, i.e., the rate cannot be reserved if the desired tee time is less than two days in the future. Days out 137 and days out start time 138 indicate how far out from a tee time the selected rate can be reserved. For example, when defining an advanced rate, the rate may be set to be available for reservation beginning five days from the desired tee time. The setting cancellation 116 allows the user administrator to define the period of time in which a reservation for the desired tee time can be canceled.

The setting rate count 140 indicates how many times a selected rate can be reserved with respect to a particular rate group and/or rate band. FIG. 2A shows a rate count of “999,” indicating that, in this example, the rate count has been set to unlimited, since golf facilities do not have 999 tee times available on any given day for a particular rate group and/or rate band. Utilization 141 indicates the upper threshold for the selected rate to be available based on the percent of tee times that are reserved during a given rate group and/or rate band. For example, an advanced rate may be made available until a golf facility has sold 50% of its tee times between 8 AM and 11 AM. Rate policy 142 allows a user administrator to enter text for special rules and policies applicable to the selected rate which will be displayed to a user reserving the selected rate. Tee icon selector 143 allows a user to select and assign time icons to the selected rate to be displayed to the user in the price matrix. Selecting save 144 will save and store the edited rate settings in a rate management database.

FIG. 2B shows one embodiment of a graphical user interface allowing an administrator user to edit and save certain rate group settings 220, which determine the details of a rate group displayed in the price matrix. A user can select rate group settings 220 using pricing rule menu 110. The user may be given the option to select a golf facility from a list of golf facilities using golf facility selector 221. The user may, with regard to the selected golf facility, select an existing rate group from a list of existing rate groups to be edited using rate group selector 222. Alternatively, the user may also create a new rate group selecting new rate group 223 or delete an existing rate group by selecting delete rate group 224. The user further may have the option to indicate whether rate group selector 222 should list active, inactive or all available rates by using filter 225.

Other editing options for a selected or new rate shown in FIG. 2B relate to the identification of the selected rate group. Each rate group can be given a rate group name 227 that may describe key aspects of the selected rate group and an abbreviated short rate group name 228. Rate group ID 226 is a unique identification for a selected rate group which is automatically assigned by the system and cannot be edited by the user. Rate group activation 229 allows the user to designate the selected rate group as active or inactive. That designation is used by filter 225. The system may also allow the user administrator to check administration setting 230, indicating that the selected rate group will only be visible to a user administrator to edit or to use in a rule.

Other default settings may include, but are not limited to default rate group start time 231 and default rate group end time 232. Default rate group start time 231 and default rate group end time 232 define the start and end time for the selected rate group. All of these default settings can be edited for a selected rate group within a specific rule. Selecting save 233 will save and store the edited rate group settings in a rate management database.

FIG. 2C shows one embodiment of a graphical user interface allowing an administrator user to edit and save certain rate band settings 320, which determine the details of a rate band displayed in the price matrix. In this embodiment, defining rate band settings 320 provides a user administrator with additional control to limit the availability of rates throughout a given day. For example, a golf facility may wish to offer unlimited advanced rates when the facility is not fully utilized, but may wish to only offer limited numbers of tee times to be sold at discounted advanced rates during peak times. In this embodiment, rate bands are not displayed in the price matrix.

A user can select rate band settings 320 using pricing rule menu 110. The user may be given the option to select a golf facility from a list of golf facilities using golf facility selector 321 and a rate group from a list of rate groups using rate group selector 322. The user may also, with regard to the selected golf facility and rate group select an existing rate band from a list of existing rate bands to be edited using rate band selector 323. Alternatively, the user may also create a new rate band selecting new rate band 324 or delete an existing rate band by selecting delete rate band 325. The user further may have the option to indicate whether rate band selector 323 should list active, inactive or all available rates by using filter 326.

Other editing options for a selected or new rate band shown in FIG. 2C relate to the identification of the selected rate band. Each rate band can be given a rate band name 328 that may describe key aspects of the selected rate band and an abbreviated short rate band name 329. Rate Band ID 327 is a unique identification for a selected rate band which is automatically assigned by the system and cannot be edited by the user. Rate band activation 330 allows the user to designate the selected rate band as active or inactive. That designation is used by filter 326. The system may also allow the user administrator to check administration setting 331, indicating that the selected rate band will only be visible to a user administrator to edit or to use in a rule.

Other default settings may include, but are not limited to default rate band start time 332 and default rate band end time 333. Default rate band start time 332 and default rate band end time 333 define the start and end time for the selected rate band. All of these default settings can be edited for a selected rate band within a specific Rule. Selecting save 334 will save and store the edited rate band settings in a rate management database.

FIG. 2D shows one embodiment of a graphical user interface allowing an administrator user to edit and save certain channel settings 420. A user can select channel settings interface 420 using pricing rule menu 110. In the preferred embodiment of the disclosed system, the term channel is a flexible concept describing 1) a reservation source; 2) a category of golfers; or 3) a combination of the two. For example, selected rates may only be available if reserved through a specific source (e.g., a golfer uses the golf facility's website to reserve a tee time, or a golfer calls a call center agent to reserve a tee time on a selected golf course), if reserved by a certain category of golfer (e.g., members, non-members). The channel may also describe a combination of source and golfer category. For example, a non-member golfer calls a call center to reserve a tee time on a selected golf course.

In a first step, the user may be given the option to select a golf facility from a list of golf facilities using golf facility selector 421. In a next step, the user may, with regard to the selected golf facility, select an existing channel from a list of existing channels to be edited using channel selector 422. Alternatively, the user may also create a new channel by selecting create new channel 423 or delete an existing channel by selecting delete channel 424. The user further may have the option to indicate whether channel selector 422 should list active channels, inactive channels or both by using filter 425.

Other editing options for a selected or new channel shown in FIG. 2D relate to the identification of the selected channel. Each channel can be given a channel name 427 that may describe key aspects of the selected channel and an abbreviated short channel name 428. Channel ID 426 is a unique identification for a selected channel which is automatically assigned by the system and cannot be edited by the user. Channel activation 429 allows the user to designate the selected channel as active or inactive. That designation is used by filter 425. The system may also allow the user administrator to check administration setting 430, indicating that the selected channel will only be visible to a user administrator to edit or to use in a rule.

Other default settings may include, but are not limited to days in 431, days in end time 432, days out 433, days out start time 434, group size selector 435 and tee time policy 436. All of these default settings can be edited for a selected channel within a specific rule. Days in 431 and days in end time 432 indicate how close to a tee time the selected rate can be reserved. These default settings can be overridden when further defining a rule. When defining a rule, the default value for the setting days in 431 and days out 432 for a combination of a selected rate and a selected channel will be set by taking the more restrictive definition from the respective defaults defined in each of the selected rate settings and selected channel settings. For example, a selected channel may have a default setting for days out 433 of seven (7) days and a selected rate may have a default setting for days out 137 of five (5) days. In this example, the system would set the days out default setting to five (5) days, i.e., the system would override the defined days out 433 setting for the selected channel and would default it to five (5) days.

The group size selector 435, allows a user administrator to define the size of groups that can be reserved by the selected channel for a specific tee time. For example, a golf facility may not want to allow single golfers to reserve a tee time, or it may only want to allow groups of two (2) and four (4) golfers to reserve a tee time. Tee time policy 436 allows the user administrator to enter text about policies that are not unique to a specific rate but instead to a specific channel. For example, all golfers making reservations online may be required to cancel at least 24 hours in advance to avoid a cancellation fee.

Pass rate indicator 437 indicates whether the actual rate amount at which the reservation was made by the golfer should be passed on to the reservation system or staff of the selected golf facility. This provides the staff of the selected golf facility with information about how much to charge the golfer when the golfer arrives for the reserved tee time, since the golfer may have reserved at an advanced rate online, a rate that may not be available at the golf facility. Pass prepaid indicator 438 indicates whether the reservation system or staff at the selected golf facility should be informed about whether or not the golfer has already paid for the reserved tee time. Ignore credit card indicator 439 indicates whether credit card information must be provided when reserving a tee time. The defaults for all of these settings defined within the channel settings 420 can be overwritten within a rule. Selecting save 440 will save and store the edited rate settings in a rate management database.

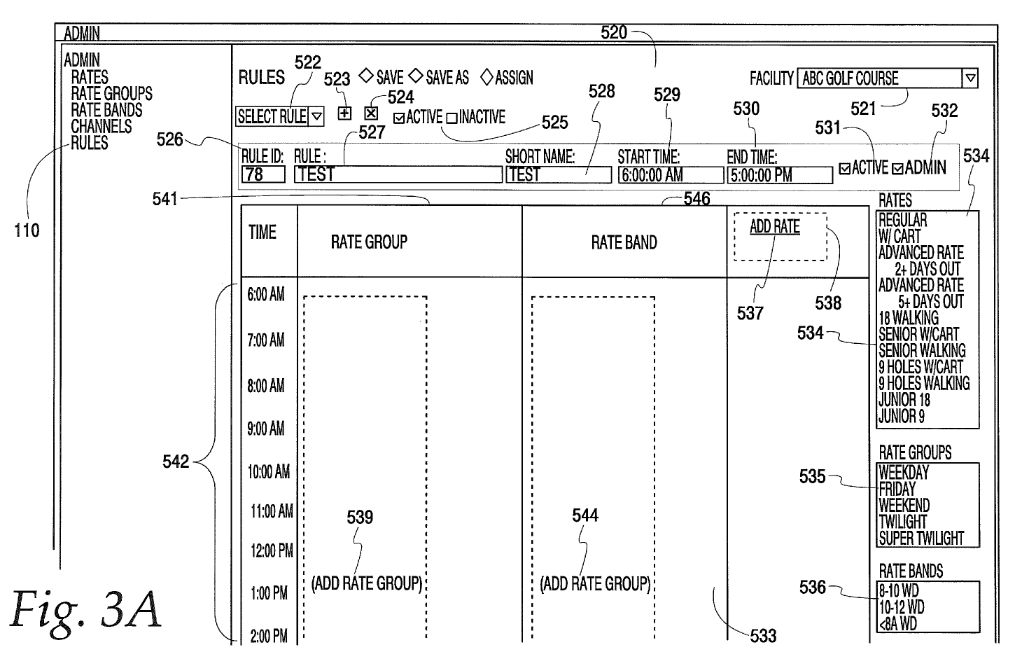

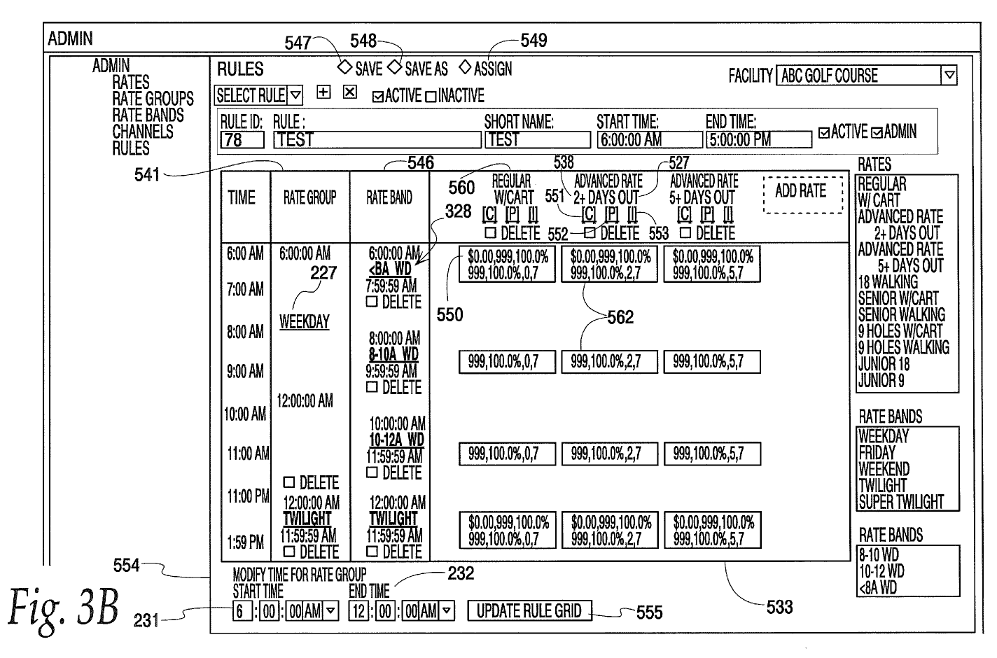

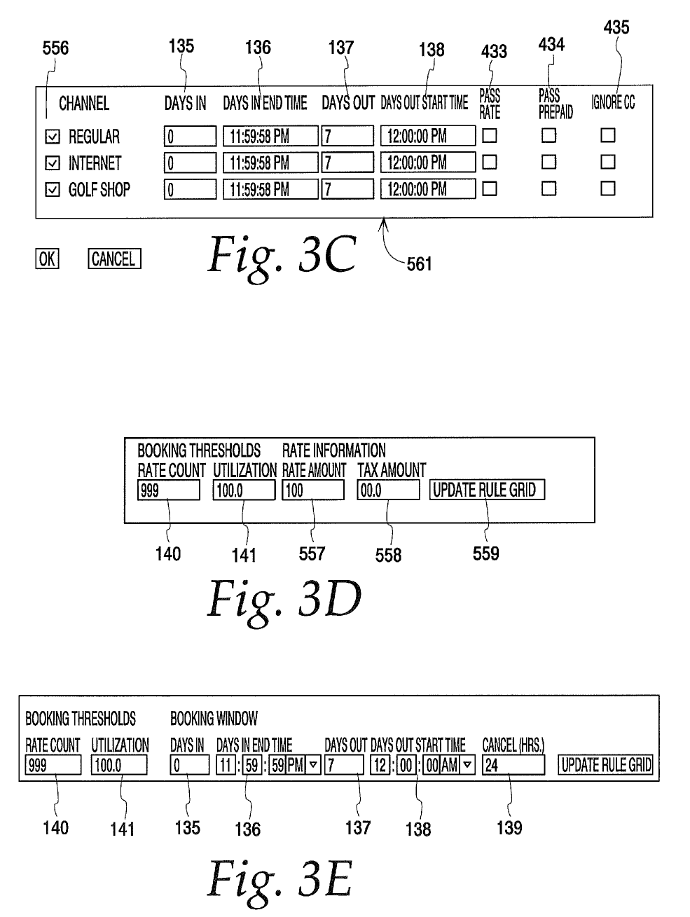

FIG. 3A shows one embodiment of a graphical user interface allowing an administrator user to edit and save certain pricing rule settings 520. A user can select pricing rule settings interface 520 using pricing rule menu 110. Every pricing rule incorporates previously defined rate settings, rate group settings, rate band settings and channel settings, along with settings defining which rates are available at what times to which channels on a given day for a selected golf facility.

The user may be given the option to select a golf facility from a list of golf facilities using golf facility selector 521. The user may also, with regard to the selected golf facility, select an existing pricing rule to be edited using pricing rule selector 522. Alternatively, the user may also create a new pricing rule by selecting create new pricing rule 523 or delete an existing pricing rule by selecting delete pricing rule 524. The user further may have the option to indicate whether pricing rule selector 522 should list active pricing rules, inactive pricing rules or both by using filter 525.

Other editing options for a pricing rule relate to the identification of the selected pricing rule. Each pricing rule can be given a pricing rule name 527 that may describe key aspects of the selected pricing rule and an abbreviated short pricing rule name 528. Pricing rule ID 526 is a unique identification for the selected pricing rule which is automatically assigned by the system and cannot be edited by the user. Pricing rule activation 531 allows the user to designate the selected pricing rule as active or inactive. That designation is used by filter 525. The system may also allow the user administrator to check administration setting 532, indicating that the selected pricing rule will only be visible to a user administrator to edit.

Other default settings may include, but are not limited to pricing rule grid start time 529 and pricing rule grid end time 530 which allows a user to determine the start and end time for time slots 542 in pricing rule grid 533.

If the user has selected to create a new pricing rule, the preferred embodiment of the disclosed system will present a blank pricing rule grid 533, as shown in FIG. 3A. In the preferred embodiment, the system further presents all available rates in rate list 534, all available rate groups in rate group list 535 and all available rate bands in rate band list 536. To add a rate to the pricing rule, the user selects one of the available rates from the rates list 534 and adds the selected rate to the pricing rule by dragging the selected rate into the designated add rate field 537 inside rate header 538 of pricing rule grid 533. This selection process can be repeated to add additional rates to pricing rule grid 533.

To add a rate group to the pricing rule, the user selects one of the available rate groups from rate group list 535 and adds the selected rate group to the pricing rule by dragging the selected rate group to add rate group field 539 inside rate group column 541 of pricing rule grid 533. The user can position the selected rate group corresponding to one of the desired time slots 542. This selection process can be repeated to add additional rate groups to pricing rule grid 533.

To add a rate band to the pricing rule, the user selects one of the available rate bands from the rate band list 536 and adds the selected rate band to the pricing rule by dragging the selected rate band to add rate band field 544 inside rate band column 546 of pricing rule grid 533. The user can position the selected rate band corresponding to one of the desired time slots 542. Rate band list 536 only shows rate bands that are associated with the respective selected rate group in rate group list 535. This selection process can be repeated to add additional rate bands to pricing rule grid 533.

FIG. 3B shows the preferred embodiment of pricing rule grid 533 after all rates, rate groups and rate bands and their respective default settings have been added to pricing rule grid 533. The user administrator can now further modify/update the default settings of the selected pricing rule. By selecting one of the rate group names 227 displayed in rate group column 541, the system allows the user to modify the default rate group start time 231 and default rate group end time 232 for the selected rate group in a separate rate group time modification field 554. The modification can be saved and pricing rule grid be updated by selecting update rule grid 555. By selecting one of the rate band names 328 displayed in rate band column 546, the system allows the user to modify the default rate band start time and the default rate band end time for the selected rate band (not shown).

The disclosed system has several other options for customizing a rate within a pricing rule. Each rate column 560 has a rate header 538 displaying a rate name 127, channel modifier 551, labeled “[C]”, promotion modifier 552, labeled “[P]” and icon modifier 553, labeled “[I].” Selecting channel modifier 551 presents a separate channel modification field 561, an embodiment of which is shown in FIG. 3C, allowing a user administrator to designate some or all channels displayed in available channel list 556 that should be able to reserve the associated selected rate. The user can further modify certain default channel settings for the designated channels, such as days in 135, days in end time 136, days out 137, days out start time 138, pass rate indicator 433, pass prepaid indicator 434 and ignore credit card indicator 435, the functionality of which has been described above.

Selecting promotion modifier 552, shown in FIG. 3B, allows the user to designate that the selected rate may only be available with a specific promotion code. A promotion code is a way for a golf facility to only allow special rates to be seen by golfers who have received specific marketing. Selecting icon modifier 553, shown in FIG. 3B, allows the user to modify which tee icons 107 for the selected rate will be displayed to a user in the price matrix shown in FIG. 1.

A modified pricing rule can be saved for subsequent use in the system by selecting save 547. A newly created pricing rule can be saved for subsequent use in the system by selecting save as 548.

FIG. 3D shows one embodiment of a modification field allowing a user to modify certain rate group settings for an associated rate. The modification field of FIG. 3D is displayed after a user selects a desired rate group details field 550, shown in FIG. 3B. The modification field shown in FIG. 3D allows a user to modify rate count 140 and utilization 141 for the selected rate within the associated rate group. Here, the user can further define certain rate details, such as the actual rate price using rate amount selector 557, which will be displayed as rate amount 105 in the price matrix shown in FIG. 1, as well as the tax amount, using tax amount selector 558. Selecting update rule grid 559 will save the modifications and update rule grid 533 of FIG. 3B accordingly.

FIG. 3E shows one embodiment of a modification field allowing a user to modify certain rate band settings for an associated rate. The modification field of FIG. 3E is displayed after a user selects a desired rate band details field 562, shown in FIG. 3B. The modification field shown in FIG. 3E allows a user to modify rate count 140 and utilization 141 for the selected rate within the associated rate band. Here, the user can also modify days in 135, days in end time 136, days out 137, days out start time 138 and cancellation 139, the functionality of which has been described above. Selecting update rule grid 563 will save the modifications and update rule grid 533 of FIG. 3B accordingly.

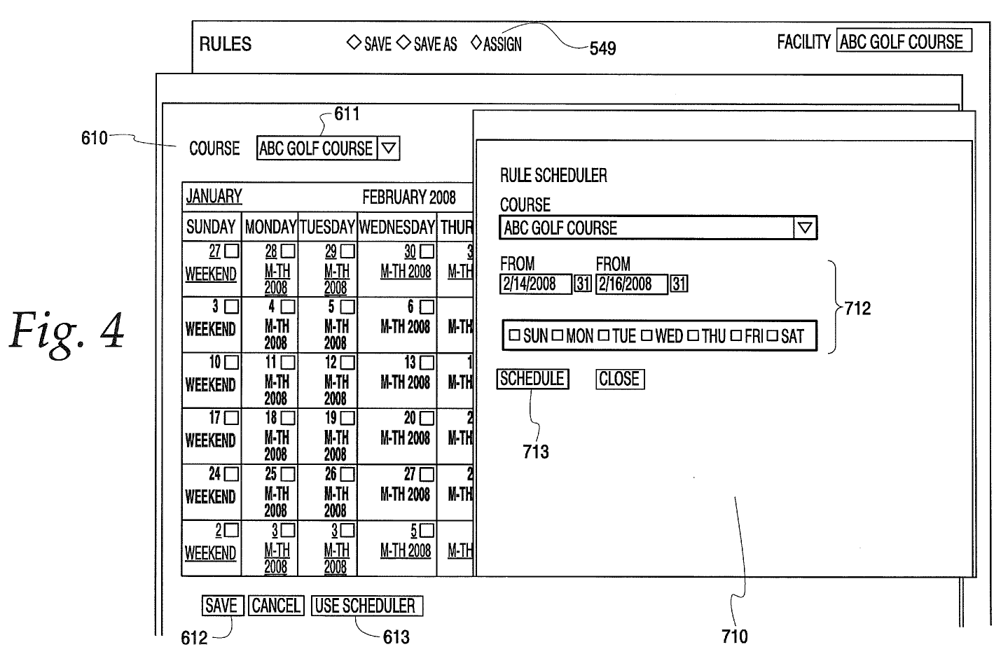

FIG. 4 shows the preferred embodiment of how a user administrator can assign a rule to one or more specific dates. In a first step, after having saved the new rule, the user must select assign 549 (also shown in FIG. 3B). The selection of assign 549 causes the system to display rule assignment overlay 610 which includes a calendar. Rule assignment overlay 610 allows the user to assign the selected rule to individual dates. This may be accomplished by selecting all the individual dates on the calendar to which the selected rule should be assigned. The user may also have the option to select a specific golf course on a selected golf facility using golf course selector 611, in case the golf facility has more than one golf course. Alternatively, a selected rule can be assigned to one or more dates by using a rule scheduler. In the preferred embodiment, selecting use scheduler 613 will cause the system to present rule scheduler overlay 710 as also shown in FIG. 4. The rule scheduler allows the user to assign the selected rule across a date range based on days-of-the-week using date and day selection fields 712. Selecting schedule 713 causes the system to close rule scheduler overlay 710 and to automatically check the scheduled dates in the calendar of rule assignment overlay 610. To finalize and save the rule assignment for subsequent use in the system the user must select save 612.

The foregoing description of the invention has been presented for purposes of illustration and description, and is not intended to be exhaustive or to limit the invention to the precise form disclosed. The description was selected to best explain the principles of the invention and practical application of these principles to enable others skilled in the art to best utilize the invention in various embodiments and various modifications as are suited to the particular use contemplated. It is intended that the scope of the invention not be limited by the specification, but be defined by the claims set forth below.

What is claimed is:

1. A method for creating and displaying a dynamic price matrix that enables a user to reserve a selected tee time on a selected golf facility, the method comprising the steps of:
defining one or more tee times available at a particular golf facility;
establishing one or more pricing rules for said tee time, said pricing rule dynamically controlling the rates and associated rate amounts at which said selected tee time is made available for reservation by said user; and
displaying to said user simultaneously a plurality of different rates and associated rate amounts that are associated with said selected tee time whereby the basis of the different associated rate amounts is the number of days that are between said selected tee time and the day said user makes the reservation.

2. The method of claim 1 wherein the step of displaying a plurality of different rates includes an additional basis of the different associated rate amounts, said additional basis being the number of times said rates associated with said selected tee time have been reserved.

3. The method of claim 1 wherein the step of displaying a plurality of different rates includes an additional basis of the different associated rate amounts, said additional basis being the utilization of said selected golf facility for said selected tee time.

4. A method for dynamically managing rates for golf facilities utilizing a rate management system including a plurality of pricing rules for defining a dynamic price matrix, the method comprising the steps of:
establishing at least one rate by defining a plurality of rate settings and naming and storing said at least one rate in a rate management database coupled to said rate management system;
establishing at least one rate group by defining a plurality of rate group settings and naming and storing said at least one rate group in said rate management database coupled to said rate management system;
establishing at least one rate band by defining a plurality of rate band settings and naming and storing said at least one rate band in said rate management database coupled to said rate management system;
establishing at least one of said plurality of pricing rules wherein establishing each one of said pricing rules includes 1) selecting at least one of said rates stored in said rate management database and assigning said selected rate to said one pricing rule, 2) selecting at least one of said rate groups stored in said rate management database and assigning said selected rate group to said one pricing rule, 3) selecting at least one of said rate bands stored in said rata management database and assigning said selected rate band to said one pricing rule;
naming and storing said one pricing rule in said rate management database;
assigning said one pricing rule to one or more specific dates; and
storing said rule assignment in said rate management database for subsequently displaying said rule assignment in a price matrix.

5. The method of claim 4 wherein the step of establishing at least one rate includes selecting an associated golf facility for said rate and wherein said plurality of rate settings allows an administrator user to further define said at least one rate in at least one of the following ways:
a. define a custom name for said rate;
b. define a currency for said rate;
c. define how close to a tee time said rate is available for reservation;
d. define how far in advance of a tee time said rate is available for reservation;
e. define how many times said rate can be reserved;
f. define how far in advance of a tee time a reserved rate can be canceled;
g. define an upper threshold for said rate to be available for reservation based on the utilization of said associated golf facility;
h. indicate whether said rate should be active or inactive within said rate management system;
i. indicate whether said rate requires prepayment by a customer;
j. indicate which tee time icons are associated with said rate; and
k. describing special rules and policies applicable to said rule.

6. The method of claim 5 wherein the step of establishing at least one rate further includes selecting one of a plurality of predefined rates from a list of rates, modifying said rate settings and storing the resulting modified rate in said rate management database for subsequent use in a price matrix.

7. The method of claim 4 wherein the step of establishing at least one rate group includes selecting an associated golf facility for said rate group and wherein said plurality of rate group settings allows an administrator user to further define said at least one rate group in at least one of the following ways:
a. define a custom name for said rate group;
b. define the start and end times for said rate group; and
c. indicate whether said rate should be active or inactive within said rate management system.

8. The method of claim 7 wherein the step of establishing at least one rate group further includes selecting one of a plurality of predefined rate groups from a list of rate groups, modifying said rate group settings and storing the resulting modified rate group in said rate management database for subsequent use in a price matrix.

9. The method of claim 4 wherein the step of establishing at least one rate band includes selecting an associated golf facility and an associated rate group for said rate band and wherein said plurality of rate band settings allows an administrator user to further define said at least one rate band in at least one of the following ways:
a. define a custom name for said rate band;
b. define the start and end times for said rate band; and
c. indicate whether said rate band should be active or inactive within said rate management system.

10. The method of claim 9 wherein the step of establishing at least one rate band further includes selecting one of a plurality of predefined rate bands from a list of rate bands, modifying said rate band settings and storing the resulting modified rate band in said rate management database for subsequent use in a price matrix.

11. The method of claim 4 further comprising the step of establishing at least one channel by defining a plurality of channel settings and naming and storing said at least one channel in said rate management database coupled to said rate management system.

12. The method of claim 11 wherein the step of establishing said channel includes selecting an associated golf facility for said channel and wherein said plurality of channel settings allow an administrator user to further define said at least one channel in at least one of the following ways:
a. define a custom name for said channel;
b. define how close to a tee time a rate is available for reservation through said channel;
c. define how far in advance of a tee time a rate is available for reservation through said channel;
d. define the size of a group of golfers which should be able to reserve a tee time through said channel;
e. indicate whether said channel should be active or inactive within said rate management system;
f. indicate whether the amount of a rate reserved through said channel should be communicated to a reservation system associated with said selected golf facility;
g. indicate whether information that payment for a tee time reserved through said channel was already made should be communicated to a reservation system associated with said selected golf facility; and
h. describing special rules and policies applicable to said channel.

13. The method of claim 12 wherein said step of establishing at least one channel further includes selecting one of a plurality of predefined channels from a list of channels, modifying said channel settings and storing the resulting modified channel in said rate management database for subsequent use in a price matrix.

14. The method of claim 4 wherein said price matrix displays rule assignments for a particular golf facility by presenting to said user for a selected tee time simultaneously a plurality of different available established rates and their associated rate amounts for an associated rate group, whereby said available associated rate amounts, in accordance with said established pricing rule, are different depending on the number of days between said selected tee time and the time said user makes a reservation for said selected tee time.
